(19) United States
(12) Patent Application Publication
(10) Pub. No.: US 2006/0093359 A1
(43) Pub. Date: May 4, 2006

(54) Loop-back wavelength division multiplexing passive optical network

(76) Inventors: Woo Ram Lee, Daejeon (KR); Seung Hyun Cho, Daejeon (KR); Byoung Whi Kim, Daejeon (KR); Jae Dong Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/110,587

(22) Filed: Apr. 19, 2005

(30) Foreign Application Priority Data
Nov. 1, 2004 (KR) 10-2004-0087926

(51) Int. Cl. H04J 14/00

(52) U.S. Cl. 398/70; 398/71

(57) ABSTRACT

Disclosed herein is an apparatus and method for managing faults of a loop-back Wavelength Division Multiplexing Passive Optical Network (WDM-PON). The apparatus includes a control light source as well as a plurality of light sources in a central office, a loop-back means for transmitting control light to the central office through a remote node optical demultiplexer or remote node optical multiplexer in a remote node, a control light receiver for receiving looped-back control light, and a control unit for maintaining power of the upstream signals, which are received by central office receivers, and power of the control light, which is received by the control light receiver, at a maximum.

### RELATED APPLICATIONS

The present application is based on, and claims priority from, Korean Application Number 2004-0087926, filed Nov. 1, 2004, the disclosure of which is incorporated by reference herein in its entirety.

### BACKGROUND OF THE INVENTION

1. Field of the Invention

The present invention relates generally to a passive optical network and, more particularly, to a system and method for managing the faults of a passive optical network that uses loop-back wavelength division multiplexing.

2. Description of the Related Art

Currently, a Digital Subscriber Line (DSL) technology using an Unshielded Twisted Pair (UTP) and a Cable Modem Termination System (CMTS) technology using a Hybrid Fiber Coaxial (HFC) network have been widely used as information transmission technologies for communication systems. It is expected to be difficult for such DSL and CMTS technologies to guarantee sufficient bandwidth and quality to provide voice, data and broadcast convergence service, which will be popularized within a few years, to subscribers. In order to solve the problem, a Fiber To The Home (FTTH) technology that connects optical fiber all the way to subscribers' homes is being researched throughout the world. The most important key to the development of the FTTH technology is the development of an optical signal transmission method that is superior in economical efficiency and mass productivity from the point of view of the characteristics of a subscriber line.

FTTH networks may be classified into a Passive Optical Network (PON) and an Active Optical Network (AON). The PON is currently being developed in the forms of an Asymmetric Transfer Mode (ATM)-PON, a B-PON, a G-PON and an E-PON. The AON is being developed into a form that connects local networks, each of which is composed of Ethernet switches, using optical fiber. In the two above-described types of FTTH networks, a data transmission optical transmission path is constructed on a single wavelength per transmission direction basis, which has a limitation in providing a quality-guaranteed bandwidth of more than 100 Mb/s to subscribers. In order to overcome such a limitation, attempts to introduce a Wavelength Division Multiplexing (WDM) technology to a FTTH subscriber network are eagerly being made.

A WDM-based FTTH network, that is, a WDM-PON, is a scheme in which the communication between a central base station and subscribers is performed using a wavelength assigned to each subscriber. Such a WDM-PON is advantageous in that the WDM-PON can provide independent and high-capacity communication service to each subscriber, and has excellent security. Furthermore, in the WDM-PON, the modulation and demodulation of light are performed for each subscriber, unlike a Time Division Multiplexing (TDM) type, so that a light source having low modulation speed and output and a receiver having narrow bandwidth can be employed. However, the WDM-PON requires light sources having intrinsic wavelengths the number of which is identical to the number of subscribers, so that an economical burden is imposed on a service provider and, therefore, there is difficulty in implementation. Accordingly, it is important to develop a low cost WDM-PON light source. In terms of the maintenance of parts, the fact that the service provider must prepare different light sources having different wavelengths for individual subscribers to provide for installation and breakdowns may impose a burden on the service provider. Therefore, the provision of the same kind of wavelength-independent light sources to all the subscribers is required to implement the WDM-PON.

A recently researched light source for the WDM-PON includes a spectrum-sliced light source that produces rays of light having a plurality of regular wavelength intervals at one time by spectrum-slicing a Broadband Light Source (BLS), such as an Amplified Spontaneous Emission (ASE) source or Light Emitting Diode (LED), using a wavelength division element, such as an Arrayed Waveguide Grating (AWG). The spectrum-sliced light source can provide the same light to each subscriber independent of wavelength. However, the spectrum-sliced light source is disadvantageous in that the output power and modulation speed thereof are low. Accordingly, in order to solve the disadvantages of the spectrum-sliced light source, an ASE injected Fabry-Perot Laser Diode (FP-LD), which is formed by injecting a spectrum-sliced ASE into a FP-LD and is used like a single mode light source, has been developed. The ASE injected FP-LD, independent of wavelength, can not only provide the same light to each subscriber but also provide high output power and high modulation speed. However, the ASE injected FP-LD is expensive and separate temperature control is required for the FP-LD of an optical network terminal.

In order to overcome the above-described disadvantages of the general WDM-PON in which an optical network terminal is equipped with a light source, a loop-back FTTH network can be taken into consideration. In this case, the loop-back FTTH network refers to the scheme in which a central office transmits light to be used at an optical network terminal along with a downstream signal, and the optical network terminal re-modulates the light, which is transmitted from the central office, to an upstream signal and retransmits the upstream signal to the central office, unlike the above-described WDM-PON.

U.S. Pat. No. 5,559,624 entitled “Communication system based on remote interrogation of terminal equipment” discloses a loop-back WDM-PON. In the loop-back FTTH such as the preceding patent, a Mach-Zehnder modulator or an Electro-Absorption (EA) modulator has been used at an optical network terminal. However, since the Mach-Zehnder modulator or an EA modulator is expensive, it is difficult for subscribers to use it. Furthermore, the Mach-Zehnder modulator or an EA modulator has high insertion loss. Accordingly, when a downstream signal, the optical power of which is reduced while the downstream signal is transmitted from a central office through a transmission path such as an optical fiber, is returned from the optical network terminal to the central office using the Mach-Zehnder modulator or an EA modulator having high insertion loss, reception power decreases, so that a problem arises in that it is difficult to completely reconstruct an upstream signal. Furthermore, the preceding invention is problematic in that power loss is high due to the structural characteristics of the WDM-PON, so that the transmission rate of upstream light is considerably limited.

In order to reliably operate such a WDM-PON, the monitoring of the wavelength and power of light depending on aging and temperature variation, the monitoring of breakage of optical fibers, and the wavelength alignment between light and an optical multiplexer/demultiplexer, the pass band of which varies with ambient temperature, should be performed. Of the above-described monitoring points, the pass band of the optical multiplexer/demultiplexer of the remote node, which is affected by variation in ambient temperature, and the wavelength alignment between the optical multiplexer/demultiplexer of the central office, the light of the central office and the light of the optical network terminals are most important. In the WDM-PON, the remote node is not supplied with power to facilitate the maintenance thereof, so that the temperature of the optical multiplexer/demultiplexer of the remote node may vary by a maximum of 100° C. For this reason, when misalignment occurs between the central office and the remote node, loss may occur in the power of a corresponding channel and the reduction of performance may occur due to crosstalk caused by other channels.

### SUMMARY OF THE INVENTION

Accordingly, the present invention has been made maintaining in mind the above problems occurring in the prior art, and an object of the present invention is to provide a system and method for managing the faults of a PON, which is capable of aligning wavelengths at a remote node optical multiplexer and demultiplexer and easily determining whether a breakage of optical fiber has occurred.

In order to accomplish the above object, the present invention provides an apparatus for managing faults of a loop-back WDM-PON, the WDM-PON having a plurality of light sources located in a central office, assigned to optical network terminals and configured to output downstream signals using unique wavelengths, a central office optical multiplexer for multiplexing the optical signals output from the plurality of central office light sources, a remote node optical demultiplexer for separating the multiplexed downstream signal according to a wavelength through demultiplexing and providing the separated downstream signals to corresponding optical network terminals, a remote node optical multiplexer for multiplexing upstream signals remodulated by the plurality of optical network terminals, a central office optical demultiplexer for demultiplexing the multiplexed upstream signal according to a wavelength, and a plurality of central office receivers for receiving and restoring the demultiplexed upstream signals, the apparatus including a control light source located in front of the central office optical multiplexer; a loop-back means for transmitting control light, which is output from the control light source, to the central office through the remote node optical demultiplexer or remote node optical multiplexer; a control light receiver for receiving looped-back control light; and a control unit for maintaining power of the upstream signals, which are received by the central office receivers, and power of the control light, which is received by the control light receiver, at a maximum.

The control light source is preferably formed of an LED. Furthermore, the central office light sources are preferably formed of single mode light sources.

The control unit preferably includes a central light source controller for maintaining the power of the received upstream signals at a maximum by varying temperatures of the central office light sources based on the power of the upstream signals received by the central office receivers.

Thermal device modules for varying the temperatures of the central office light sources under the control of the control unit are preferably attached to the central office light sources.

The control unit preferably includes a control light source controller for maintaining the power of the received control light at a maximum by varying temperatures of the central office optical multiplexer and the central office optical demultiplexer based on the power of the control light received by the control light receiver.

Thermal device modules for varying the temperatures of the central office optical multiplexer and the central office optical demultiplexer under the control of the control unit that are preferably attached to the central office optical multiplexer and the central office optical demultiplexer.

The central office preferably further includes a circulator that is located in the central office and transmits the optical signal, which is reflected and returned by Fresnel reflection through downstream optical fibers to the control unit.

The control unit preferably further includes a downstream optical fiber breakage determination unit for determining whether the downstream optical fiber has been broken based on a size of the optical signal reflected and returned by Fresnel reflection through the downstream optical fiber; and a upstream optical fiber breakage determination unit for determining that an upstream optical fiber has been broken when each of the upstream signals input to the central office receivers is less than a reference value.

The upstream optical fiber breakage determination unit is preferably formed of a NAND gate.

The central office optical multiplexer and the central office optical demultiplexer are preferably formed of AWGs.

The loop-back means may be constructed by connecting the remote node optical demultiplexer with the remote node optical multiplexer through an optical fiber.

The loop-back means may be formed of an optical reflector, and an optical absorber for absorbing the control light input to the remote node optical demultiplexer may further be included behind the remote node optical demultiplexer.

A coupler for branching the downstream optical signal to be demultiplexed and assigned to the optical network terminals may be located between the remote node and the optical network terminals, and a circulator for adjusting the direction of the upstream optical signal transmitted from the optical network terminals may be located between the coupler and the optical network terminals.

A coupler for branching the multiplexed downstream optical signal may be located between the central office and the remote node optical multiplexer, and a circulator for transmitting part of the downstream optical signal, which is branched off by the coupler, to the optical network terminals and transmitting the upstream optical signal, which is transmitted from the optical network terminals, to the central office may be located between the coupler and the remote node optical multiplexer.

A coupler for branching the multiplexed downstream optical signal may be located between the central office and the remote node optical multiplexer, and a circulator for adjusting the direction of the multiplexed downstream or upstream optical signal may be located between the central office optical multiplexer and the coupler.

In order to accomplish the above object, the present invention provides a method of managing faults of a loop-back WDM-PON, the WDM-PON having a plurality of light sources located in a central office, assigned to optical network terminals and configured to output downstream signals using unique wavelengths, a central office optical multiplexer for multiplexing the optical signals output from the plurality of central office light sources, a remote node optical demultiplexer for separating the multiplexed downstream signal according to a wavelength through demultiplexing and providing the separated downstream signals to corresponding optical network terminals, a remote node optical multiplexer for multiplexing upstream signals remodulated by the plurality of optical network terminals, a central office optical demultiplexer for demultiplexing the multiplexed upstream signal according to a wavelength, and a plurality of central office receivers for receiving and restoring the demultiplexed upstream signals, the method including the first step of multiplexing control light output from a control light source, along with the downstream signal; the second step of passing the control light through the remote node optical demultiplexer and the remote node optical multiplexer, multiplexing the control light along with the upstream signal, and transmitting the multiplexed signal to the central office in a loop-back manner; the third step of separating the signal, which is received by the central office, into the control light and the upstream signal by demultiplexing the signal; and the fourth step of maintaining power of the upstream signals received by the central office receivers and power of the control light received by the control light receiver at a maximum.

The fourth step is preferably performed by maintaining the power of the received upstream signals at a maximum by varying temperatures of the central office light sources based on the power of the upstream signals received by the central office receivers.

The fourth step is preferably performed by maintaining the power of the received control light at a maximum by varying temperatures of the central office optical multiplexer and the central office optical demultiplexer based on the power of the control light received by the control light receiver.

The method may further include the steps of determining whether the downstream optical fiber has been broken based on a size of the optical signal reflected and returned by Fresnel reflection through the downstream optical fiber; and determining that an upstream optical fiber has been broken when each of the upstream signals input to the central office receivers is less than a reference value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a loop-back WDM-PON according to a first embodiment of the present invention;

FIG. 2 is a diagram showing the construction of an apparatus for managing the faults of a loop-back WDM-PON according to the first embodiment of the present invention.

FIG. 3 is a diagram showing the detailed construction of the control unit according to an embodiment of the present invention;

FIG. 4 is a flowchart showing a process of keeping track of a wavelength to maintain a received control optical light channel at a maximum in accordance with an embodiment of the present invention;

FIG. 5 is a flowchart showing a process of keeping track of a wavelength to maintain a received central office light source channel at a maximum in accordance with an embodiment of the present invention;

FIG. 6 is a diagram showing a WDM-PON with a coupler and a circulator being shared by subscribers according to a second embodiment of the present invention;

FIG. 7 is a diagram showing the construction of an apparatus for managing the faults of a loop-back WDM-PON according to the second embodiment of the present invention;

FIG. 8 is a diagram showing a WDM-PON in which a coupler and a circulator are shared by optical network terminals, according to a third embodiment of the present invention; and

FIG. 9 is a diagram showing an apparatus for managing the faults of a loop-back WDM-PON according to the third embodiment of the present invention.

### DESCRIPTION OF THE PREFERRED EMBODIMENTS

Reference now should be made to the drawings, in which the same reference numerals are used throughout the different drawings to designate the same or similar components.

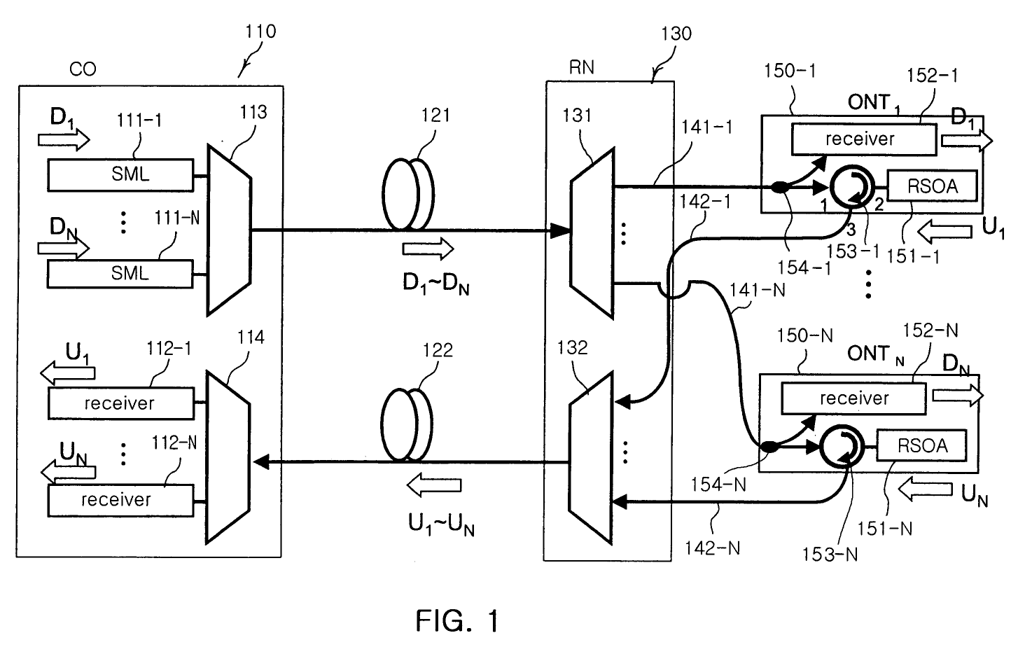

FIG. 1 is a diagram illustrating the configuration of a loop-back WDM-PON according to a first embodiment of the present invention.

Referring to FIG. 1, an RSOA-based loop-back WDM-PON system according to the first embodiment of the present invention includes a central office (CO) 110, downstream and upstream optical fibers 121 and 122, a remote node (RN) 130, downstream signal optical fibers 141-1 to 141-N, upstream signal optical fibers 142-1 to 142-N, and optical network terminals (ONTs) 150-1 to 150-N.

The central office 110 includes central office light sources 111-1 to 111-N, central office receivers 112-1 to 112-N, a central office optical multiplexer 113, and a central office optical demultiplexer 114. For example, Single Mode Laser diodes (SMLDs), such as Distributed Feedback Laser Diodes (DFB-LDs), may be used as the central office light sources 111-1 to 111-N, and are constructed separately or in an integrated array form. The single mode laser diodes modulate electrical signals to downstream signals Di (i=1˜N) using rays of light having N intrinsic wavelengths that are assigned to the N optical network terminals 150-1 to 150-N, respectively. The central office receivers 112-1 to 112-N may also be constructed using PIN Photodiodes (PIN-PDs) or Avalanche Photodiodes (APDs), and receive upstream signals from the optical network terminals 150-1 to 150-N. The central office multiplexer 113 multiplexes the outputs of the N single mode central office light sources 111-1 to 111-N and transfers a multiplexed downstream signal to the downstream optical fiber 121.

The remote node 130 includes a remote node optical demultiplexer 131 and a remote node optical multiplexer 132. The optical demultiplexer 131 demultiplexes the multiplexed downstream signal and then distributes demultiplexed downstream signals to the individual optical network terminals 150-1 to 150-N through the downstream signal optical fibers 141-1 to 141-N according to wavelength.

The optical network terminals 150-1 to 150-N include RSOAs 151-1 to 151-N, terminal optical receivers 152-1 to 152-N, circulators 153-1 to 153-N and couplers 154-1 to 154-N.

The couplers 154-1 to 154-N divide downstream signals transferred through the downstream signal optical fibers 141-1 to 141-N and distribute divided optical signals to the RSOAs 151-1 to 151-N and the optical receivers 152-1 to 152-N in consideration of the receiving sensitivity of the terminal receivers 152-1 to 152-N and the power budget of the upstream signals. That is, the couplers 154-1 to 154-N function to branch the downstream signals into first optical signals, which will be transferred to the RSOAs 151-1 to 151-N, and second optical signals, which will be transferred to the optical receivers 152-1 to 152-N.

The circulators 153-1 to 153-N are positioned between the couplers 154-1 to 154-N and the RSOAs 151-1 to 151-N, and function to transfer upstream signals Ui (i=1˜N) to the remote node optical multiplexer 132 by adjusting the directions of the upstream signals that are transmitted from the RSOAs 151-1 to 151-N.

The terminal optical receivers 152-1 to 152-N receive and reconstruct the downstream signals Di and provide the downstream signals Di to subscribers.

The RSOAs 151-1 to 151-N operate input downstream signals Di in a gain saturation region, re-modulate operating currents to the upstream signals Ui, and transmit the upstream signals Ui to the central office 110.

The light modulated to the upstream signals is passed through the circulators 153-1 to 153-N and the upstream signal optical fibers 142-1 to 142-N, multiplexed through the optical multiplexer 132 of the remote node 130, and input to the central office 110 through the upstream optical fiber 122. The multiplexed light input to the central office 110 is demultiplexed according to channel, and input to the central office optical receivers 112-1 to 112-N. The central office optical receivers 112-1 to 112-N finally receive the upstream signals U_{N}.

However, when, in the loop-back WDM-PON according to the first embodiment, the pass bands of the optical multiplexer and optical demultiplexer of the remote mode 130 vary with the variation in the ambient temperature of the remote node 130, problems arise in that not only a loss in the power of a corresponding channel but also a reduction in performance due to the crosstalk of some other channel may occur.

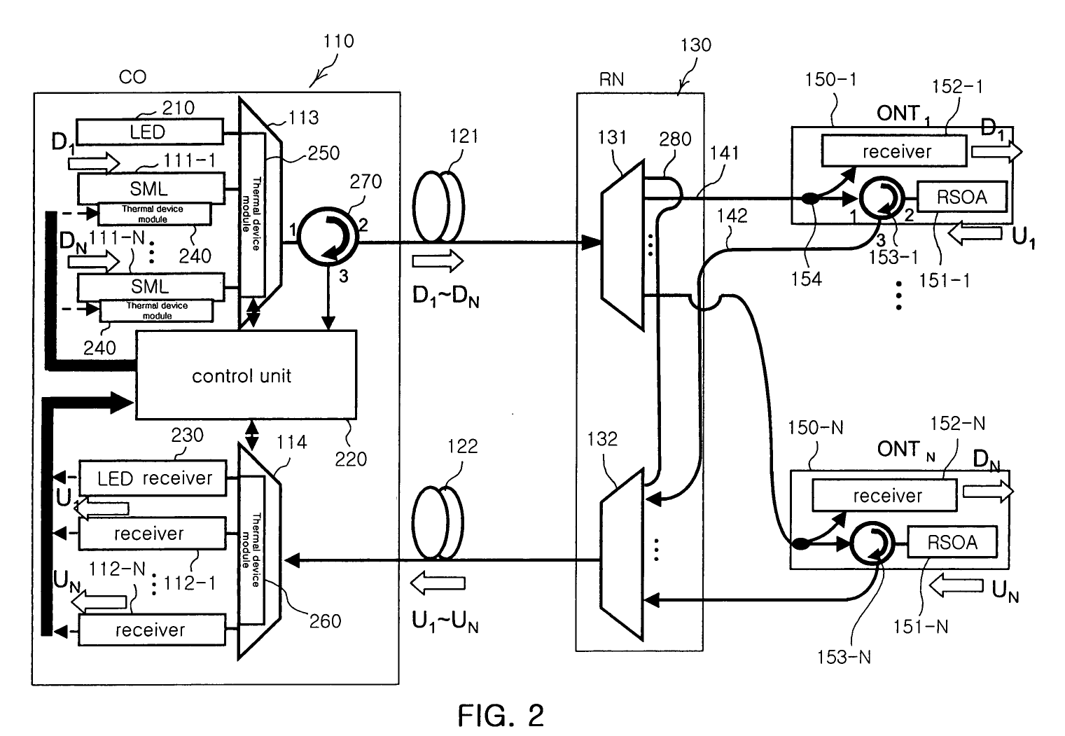

FIG. 2 is a diagram showing the construction of an apparatus for managing the faults of a loop-back WDM-PON according to the first embodiment of the present invention.

Referring to FIG. 2, the management apparatus of the loop-back WDM-PON according to the first embodiment of the present invention functions to maintain system performance when the pass bands of the remote node optical multiplexer 131 and the remote node optical demultiplexer 132 vary due to variation in ambient temperature, and to detect breakage of the downstream and upstream optical fibers 121 and 122. The management apparatus of the loop-back WDM-PON includes a control light source 210, a control light receiver 230, thermal device modules 240, 250 and 260, a circulator 270 and a loop-back means 280.

The control light source 210 is placed in the central office 110, and is located in front of the central office optical multiplexer 113. A light source having a wide optical spectrum, such as a Light Emitting Diode (LED), is preferably used as the control light source 210. The control light receiver 230 functions to receive the output of the control light source that is looped back through the remote node 130.

The control light source 210 and the control light receiver 230 are used to align the wavelengths of pass bands. The remote node optical multiplexer and demultiplexer 131 and 132 and the central office optical multiplexer and demultiplexer 113 and 114 are preferably formed of AWGs.

That is, the control light output from the control light source 210 of the central office 110, spectrum-sliced and multiplexed along with the downstream signal while passing through the central office optical multiplexer 113, is passed through the circulator 115 and the downstream optical fiber 121, and reaches the remote node 130. Thereafter, the control light output from the control light source 210 is multiplexed along with the upstream signal and transmitted to the upstream fiber 122 through the loop-back means 280 that forms a channel between the remote node optical multiplexer 131 and the remote node optical demultiplexer 132, which is assigned to the control light.

The control light passed through the upstream optical fiber 122 is input to the control light receiver 230 through the central office optical demultiplexer 114. In the case where the LED is used as the control light source 210, the optical spectrum of the output thereof is 50 nm and therefore wide. It can be understood that considering that the channel of the AWG has an optical bandwidth narrower than 1 nm, the power of light input to the control signal receiver 230 increases in proportion to the degree of alignment of band passes of the central office optical multiplexer and demultiplexer 113 and 114 and the remote node optical multiplexer and demultiplexer 131 and 132. Accordingly, if the control unit 220 always maintains the power of the control light receiver 230 at the maximal value, the central office optical multiplexer and demultiplexer 113 and 114 can keep track of the wavelength drift of the pass band of the remote node optical multiplexer and demultiplexer 131 and 132 attributable to the variation in the temperature of the remote node 130. Furthermore, the control unit 220 changes the pass band of the central office optical multiplexer and demultiplexer 131 and 132 using the thermal device modules 250 and 260.

Once the pass band of the central office optical multiplexer and demultiplexer 113 and 114 is aligned with the pass band of the remote node multiplexer and demultiplexer 131 and 132, the wavelength of one of the central office light sources 111-1 to 111-N must be aligned with the wavelength of the central office optical multiplexer and demultiplexer 113 and 114. This can be effected by controlling the thermal device modules 240, which are connected to the central office light sources 111-1 to 111-N, using the control unit 220 so as to maintain the output of the central office receivers 112-1 to 112-N, which have received the upstream optical signals looped back from the optical network terminals 150-1 to 150-N, at a maximum, as shown in FIG. 2, like the case of the control light source 210. The control unit 220 detects breakage of the downstream and upstream optical fibers 121 and 122 as well as the alignment of wavelengths.

Although FIG. 2 illustrates the passive optical network using the RSOAs 151-1 to 151-N for ease of description, the present invention is not limited to this case, but may be applied to loop-back WDM-PONs using various remodulation schemes.

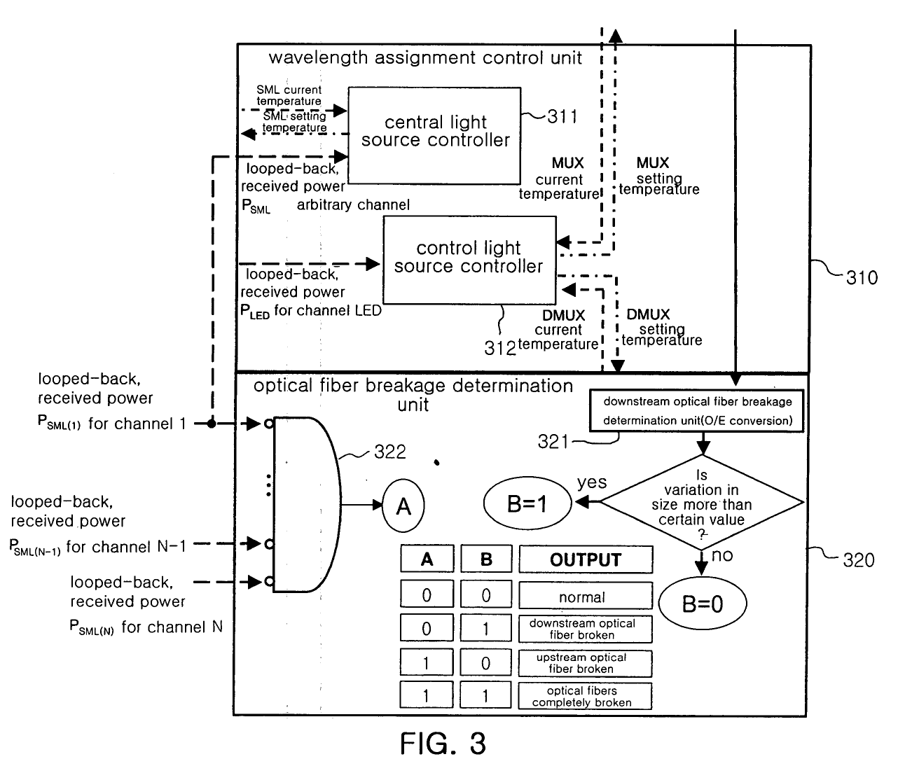

FIG. 3 is a diagram showing the detailed construction of the control unit 220 according to an embodiment of the present invention.

Referring to FIG. 3, the control unit 220 according to the embodiment of the present invention includes a wavelength alignment control unit 310 and an optical fiber breakage determination unit 320.

The wavelength alignment control unit 310 includes a central office light source controller 311 for maintaining the power of the received light of the central office light sources 111-1 to 111-N at a maximum and a control light source controller 312 for maintaining the power of the received light of the control light source 210 at a maximum.

The central light source controller 311 changes the current temperature of the central office light sources 111-1 to 111-N while monitoring both the power of the looped-back light of the central office light sources 111-1 to 111-N and the current temperature of the central office light sources 111-1 to 111-N. That is, the central office light source controller 311 controls the temperature of the central office light sources 111-1 to 111-N using the thermal device modules 240 based on the power of the upstream signals, which are received by the central office receivers 112-1 to 112-N, so as to maintain the power of the looped-back, received upstream signals at a maximum.

In the same manner, the control light source controller 312 changes the current temperature of the central office optical multiplexer and demultiplexer 113 and 114 while monitoring both the power of the looped-back light of the control light source 210 and the current temperature of the central office optical multiplexer and demultiplexer 113 and 114. That is, the control light source controller 312 controls the temperature of the central office optical 15 multiplexer and demultiplexer 113 and 114 using the thermal device modules 250 and 260 based on the power of the control light, which is received by the control light receiver 230, so as to maintain the power of the looped-back, received control light at a maximum.

The optical fiber breakage determination unit 320 is divided into a downstream optical fiber breakage determination unit 321 and an upstream optical fiber breakage determination unit 322.

The downstream optical fiber breakage determination unit 321 can determine whether the downstream optical fiber 121 has been broken based on the size of an optical signal that is returned through the downstream optical fiber 121 by Fresnel reflection. The principle of this is described below. When the downstream optical fiber 121 has been broken, the downstream light bound for the remote node 130 is reflected by Fresnel reflection on a broken portion at a rate higher than usual. The downstream light returned by Fresnel reflection is input to the control unit 220 through the circulator 270 of the central office 110 and is measured, and it is determined that breakage has occurred when the reflection occurs at a higher rate than usual. That is, the reflected, returned downstream light is converted into an electrical signal by photoelectric conversion through the downstream optical fiber breakage determination unit 321. When the reflected, returned downstream light is reflected at a higher rate than usual, that is, when it is determined that the downstream optical fiber 121 has been broken, the downstream optical fiber breakage determination unit 321 sets B to 1. In contrast, when the downstream light is reflected at the same rate as usual, the downstream optical fiber breakage determination unit 321 sets B to 0.

Furthermore, when the upstream light input to the central office receiver 119 is equal to or less than a reference value, the downstream optical fiber breakage determination unit 321 determines that the upstream optical fiber 122 has been broken. The downstream optical fiber breakage determination unit 321 is preferably formed of a NAND gate. Accordingly, when the upstream light input to the central office receiver 119 is less than the reference value, that is, when the upstream optical fiber 122 has been broken, A is set to 1. Otherwise A is set to 0.

Accordingly, the optical fiber breakage determination unit 320 determines that both the downstream and upstream optical fibers 121 and 122 are normal if A=0 and B=0, determines that only the downstream optical fiber 121 has been broken if A=0 and B=1, determines that only the upstream optical fiber 122 has been broken if A=1 and B=0, and determines that both the downstream and upstream optical fibers 121 and 122 have been broken if A=1 and B=1.

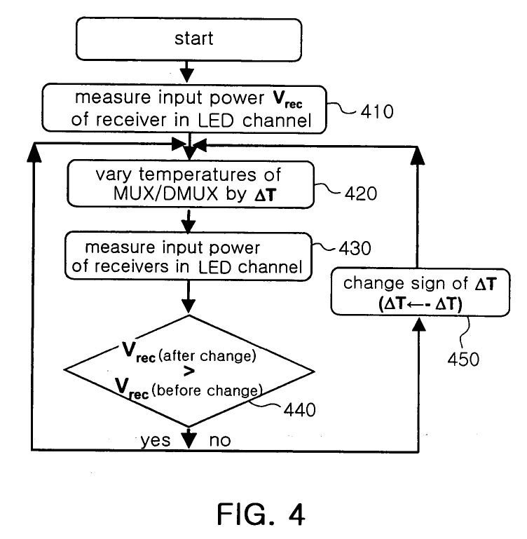

FIG. 4 is a flowchart showing a process of keeping track of a wavelength to maintain a received control optical light channel at a maximum in accordance with an embodiment of the present invention.

Referring to FIG. 4, the control unit 220 measures the input power V_{rec} of the control light receiver 230 at step 410, and changes the temperature of the central office optical multiplexer and demultiplexer 113 and 114 by +ΔT using the thermal device modules 250 and 260 at step 420. Thereafter, it is determined whether V_{rec} has increased compared to the previous power level at step 440. If V_{rec} has increased, the temperature is changed by +ΔT at step 420. If V_{rec} has decreased, the temperature is changed by −ΔT at step 450. Through this process, the maximal value of V_{rec} can always be maintained.

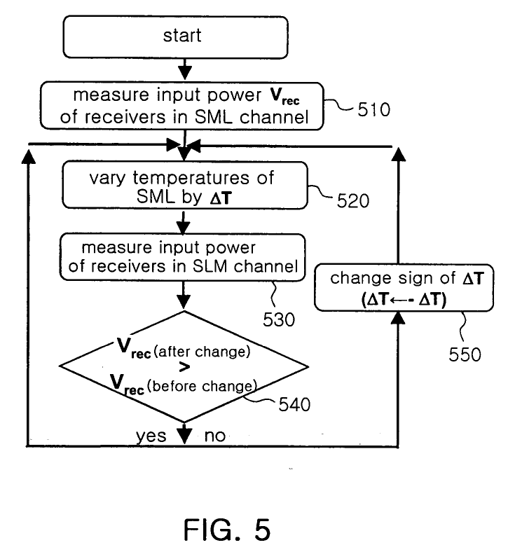

FIG. 5 is a flowchart showing a process of keeping track of a wavelength to maintain a received central office light source channel at a maximum in accordance with an embodiment of the present invention.

Referring to FIG. 5, the input power V_{rec} of the central office receivers 112-1 to 112-N is measured at step 510, and the temperature of the central office optical multiplexer and demultiplexer 113 and 114 is changed by +ΔT using the thermal device modules 250 and 260 at step 520. Thereafter, it is determined whether V_{rec} has increased compared to the previous power level at step 540. If V_{rec} has increased, the temperature is changed by +ΔT at step 520. If V_{rec} has decreased, the temperature is changed by −ΔT at step 550. Through this process, the maximal value of V_{rec} can always be maintained.

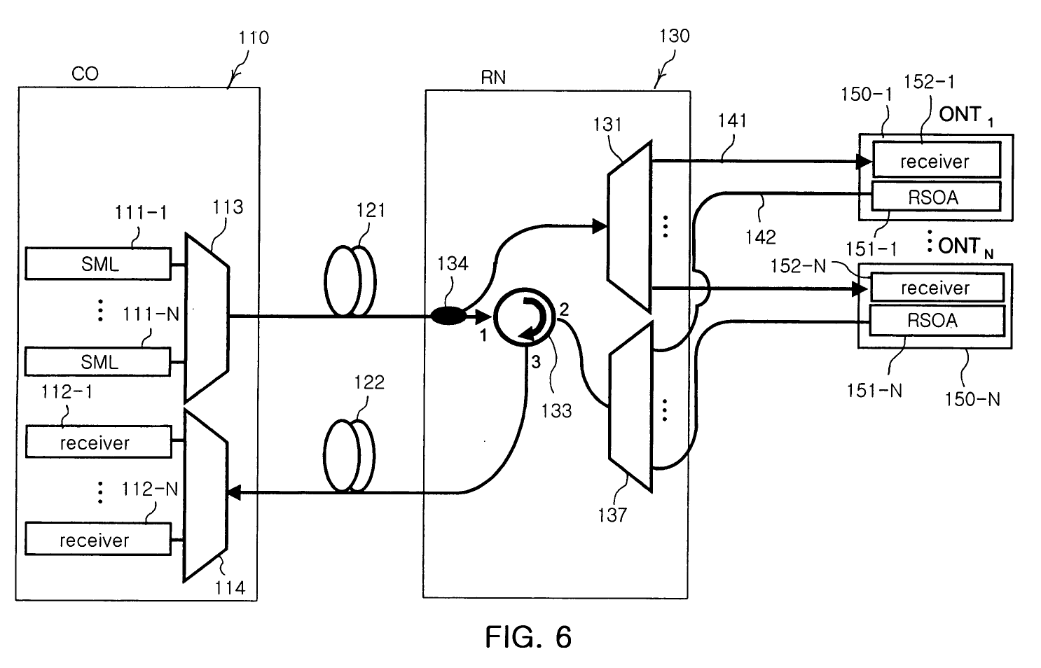

FIG. 6 is a diagram showing a WDM-PON with a coupler and a circulator being shared by optical network terminals according to a second embodiment of the present invention.

The loop-back WDM-PON according to the first embodiment of the present invention, which is shown in FIG. 1, has a structure in which each of the optical network terminals 150-1 to 150-N has one of the couplers 154-1 to 154-N and one of the circulators 153-1 to 153-N, so that it imposes an economic burden and has a somewhat complex structure. The loop-back WDM-PON according to the second embodiment of the present invention is constructed to have a structure capable of reducing network construction costs and allowing network construction to be easily achieved in such a way that a coupler 134 and a circulator 133 are located in a remote node 130 and shared by optical network subscribers.

Referring to FIG. 6, in the loop-back WDM-PON according to the second embodiment of the present invention, the multiplexed downstream optical signal is input from a central office 110 through a downstream optical fiber 121 to the remote node 130. Then the coupler 134 located in the remote node 130 distributes the downstream optical signal so that the downstream optical signal is divided and transmitted to the network receivers 152-1 to 152-N and RSOAs 151-1 to 151-N of the optical network terminals 152-1 to 152-N. Subsequently, a downstream optical signal (a first downstream signal) to be transmitted to the RSOAs 151-1 to 151-N is branched off and is input to the optical network terminals 150-1 to 150-N through the downstream signal optical fibers 141-1 to 141-N.

A downstream optical signal (a second downstream signal) to be input to and remodulated in the RSOAs 151-1 to 151-N is branched off, input to a remote node optical multiplexer/demultiplexer 137, separated according to wavelength, and input to the optical network terminals 150-1 to 150-N. Thereafter, light signals remodulated to an upstream signal in and output from the RSOAs 151-1 to 151-N are input to and multiplexed in the remote node optical multiplexer/demultiplexer 137, and are input to the central office 110 through the circulator 133 and the upstream optical fiber 122, thus restoring an upstream optical fiber. The circulator 133 functions to adjust the direction of an optical signal so as to transmit the branched-off optical signal to the RSOAs 151-1 to 151-N through the remote node optical multiplexer/demultiplexer 137 or so as to transmit the upstream optical signal, which is output from the remote node optical multiplexer/demultiplexer 137, to the central office 110 through the upstream optical fiber 122.

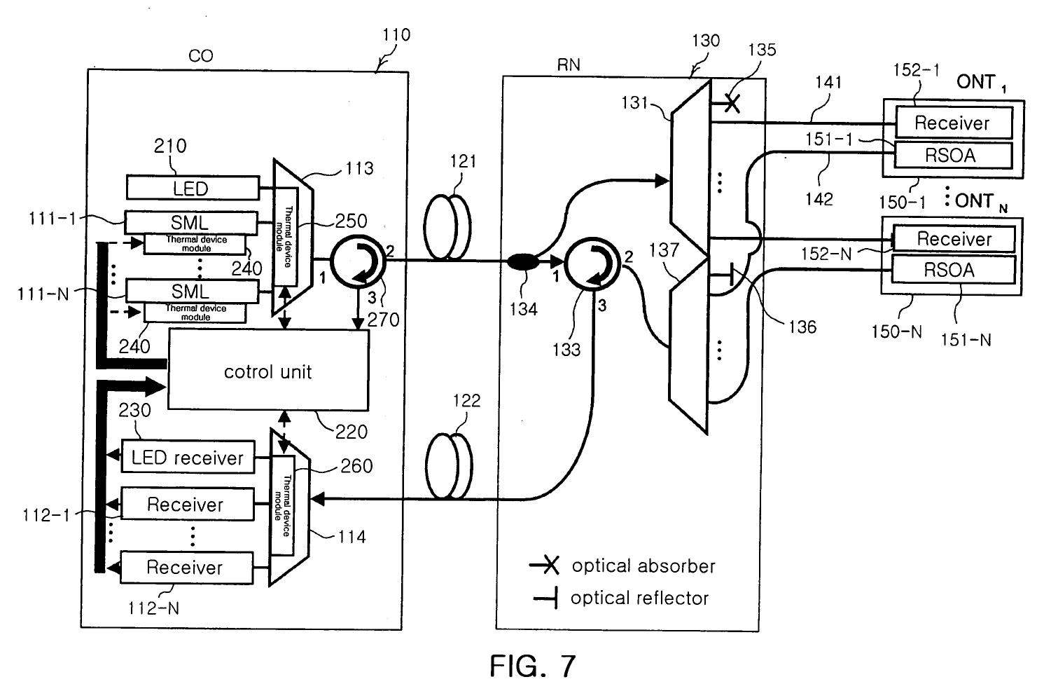

FIG. 7 is a diagram showing the construction of an apparatus for managing the faults of a loop-back WDM-PON according to the second embodiment of the present invention.

Referring to FIG. 7, in the apparatus for managing the faults of a loop-back WDM-PON according to the second embodiment of the present invention, an optical absorber 135 is placed in a remote node optical multiplexer 131 and an optical reflector 136 is placed in a remote node optical multiplexer/demultiplexer 137.

Part of the control light output from a control light source 210 is transmitted to the remote node optical multiplexer/demultiplexer 137 through a coupler 134 placed in a remote node 130, and the remaining part of the control light is transmitted to the remote node optical multiplexer 131. Then the part of the control light transmitted to the remote node optical multiplexer/demultiplexer 137 is reflected by the optical reflector 136, multiplexed by the remote node optical multiplexer/demultiplexer 137, and transmitted to the control unit 220 of the central office 110. The remaining part of the control signal input to the remote node optical multiplexer 131 is absorbed by the optical absorber 135 and is eliminated.

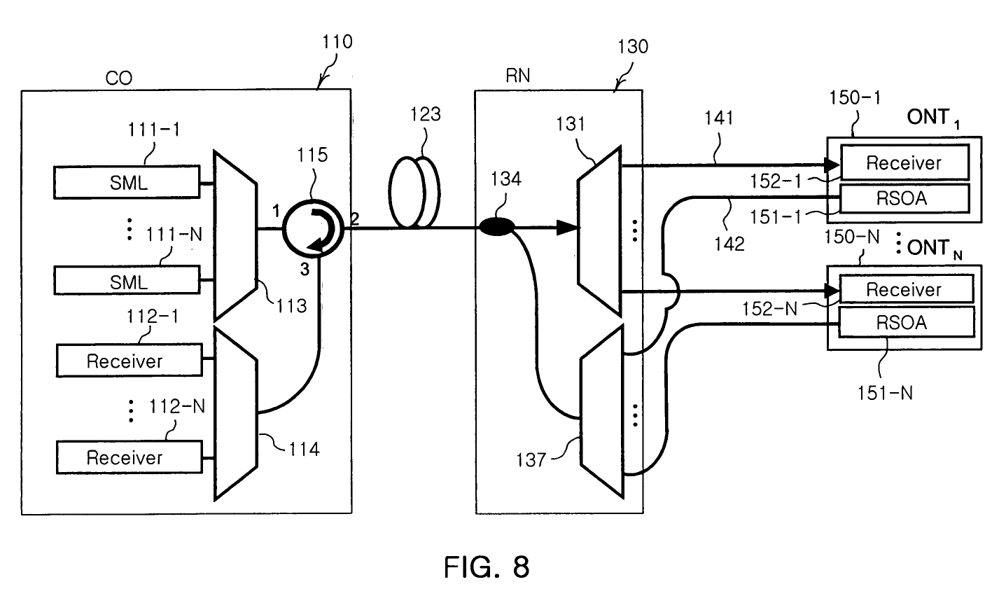

FIG. 8 is a diagram showing a WDM-PON in which a coupler and a circulator are shared by optical network terminals, according to a third embodiment of the present invention.

The WDM-PON according to the second embodiment of the present invention is configured to use the upstream optical fiber 121 and the downstream optical fiber 122, whereas the loop-back WDM-PON according to the third embodiment of the present invention is configured to transmit both upstream and downstream optical signals through a single optical fiber.

Referring to FIG. 8, in the loop-back WDM-PON according to the third embodiment of the present invention, a circulator 115 is placed in a central office 110 and a coupler 234 is placed in a remote node 130. The output of single mode light sources 111-1 to 111-N modulated to downstream signals in the central office 110 are multiplexed in an optical multiplexer 113, and input to the remote node 130 through the circulator 115 and an upstream/downstream optical fiber 123. The downstream optical signal input to the remote node 130 is distributed in the coupler 134 of the remote node 130 and transmitted to optical network terminal receivers 152-1 to 152-N and RSOAs 151-1 to 151-N. Subsequently, a downstream optical signal (a first downstream signal) to be transmitted to the optical network terminal receivers 152-1 to 152-N is input to the optical network receivers 152-1 to 152-N through the optical demultiplexer 131 of the remote node 130 and downstream signal optical fibers 141-1 to 141-N, and then a downstream signal is restored. A downstream optical signal (a second downstream optical signal) to be input to the RSOAs 151-1 to 151-N and remodulated to an upstream signal is separated according to wavelength in the remote node optical multiplexer/demultiplexer 137, and input to the RSOAs 151-1 to 151-N of the optical network terminals 150-1 to 150-N through upstream optical fibers 142-1 to 142-N. Thereafter, optical signals remodulated to upstream signals in and output by the RSOAs 151-1 to 151-N are input to the upstream optical fibers 142-1 to 142-N through the upstream and downstream optical fibers 123, multiplexed therein, and transmitted to the central office 110 through the coupler 134 and the upstream/downstream optical fibers 123. The upstream optical signal is distributed according to wavelength in the central office optical demultiplexer 114, and input to the central office receivers 112-1 to 112-N, thus restoring an upstream signal.

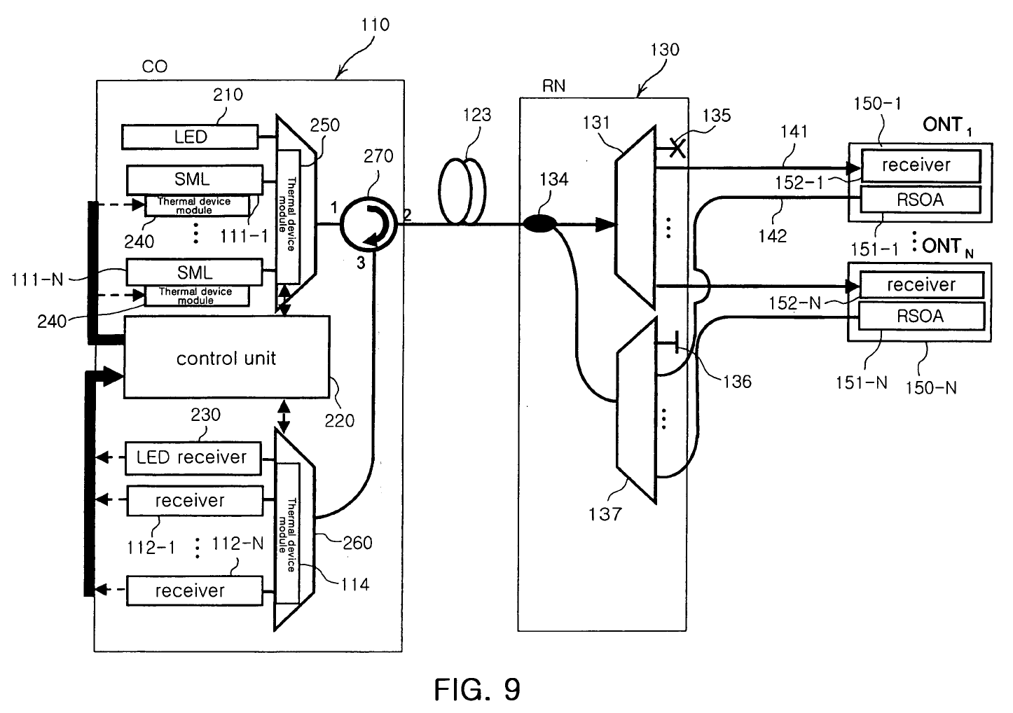

FIG. 9 is a diagram showing an apparatus for managing the faults of a loop-back WDM-PON according to the third embodiment of the present invention.

Referring to FIG. 9, the apparatus for managing the faults of a loop-back WDM-PON according to the third embodiment of the present invention monitors breakage of an optical fiber 123 using a single optical fiber rather than upstream and downstream optical fibers. That is, control light output from a control light source 210 is branched by a coupler 134, and part of the control light is input to a remote node optical multiplexer/demultiplexer 137 and the remaining part of the control light is input to the remote node optical multiplexer 131. The part of the control light input to the remote node optical multiplexer/demultiplexer 137 is reflected by an optical reflector 136 and transmitted to the circulator 270 of the central office 27 through the optical fiber 123, and the circulator 270 transmits the returned control light to a control unit 220 through a central office demultiplexer 260.

Furthermore, the apparatus for managing the faults of a loop-back WDM-PON according to the third embodiment of the present invention can easily monitor breakage of an optical fiber using the method of determining whether the upstream optical fiber 122 has been broken, which has been described in conjunction with FIG. 3. That is, when the upstream optical signals are less than the reference value, it is determined that the optical fiber 123 has been broken.

The method of maintaining system performance when the pass bands of the remote node optical multiplexer and demultiplexer 131 and 132 change due to variation in the ambient temperature of the loop-back WDM-PON, and the method of determining whether the downstream and upstream optical fibers 121 and 122 have been broken may be implemented on one of computer-readable storage media using computer-readable code. The computer-readable storage media include all types of storage media in which computer system-readable data are stored. Examples of the computer readable storage media are Read-Only Memory (ROM), Random Access Memory (RAM), Compact Disk (CD)-ROM, a magnetic tape, a floppy disk, and an optical data storage, or the methods can be implemented in the form of carrier waves, such as line transmission via the Internet. Furthermore, a computer-readable storage medium is distributed throughout a computer system connected via a network, so that the computer-readable code can be stored and executed in a distributed manner.

In accordance with the present invention described above, there is an advantage in that the loss of optical power of a corresponding channel and the decrease in performance attributable to the crosstalk components of other channels can be minimized in such a way that the central office devices automatically keep track of a wavelength based on the wavelength of the pass band when the pass bands of the optical multiplexer and the optical demultiplexer placed in the remote node change due to ambient temperature.

Furthermore, in accordance with the present invention, in the loop-back WDM-PON, breakage of optical fibers for transmitting downstream and upstream optical signals can be easily monitored, so that there is another advantage in that the reliability of the WDM-PON can be further increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for managing faults of a loop-back Wavelength Division Multiplexing Passive Optical Network (WDM-PON), the WDM-PON having a plurality of light sources located in a central office, assigned to optical network terminals and configured to output downstream signals using unique wavelengths, a central office optical multiplexer for multiplexing the optical signals output from the plurality of central office light sources, a remote node optical demultiplexer for separating the multiplexed downstream signal according to a wavelength through demultiplexing and providing the separated downstream signals to corresponding optical network terminals, a remote node optical multiplexer for multiplexing upstream signals remodulated by the plurality of optical network terminals, a central office optical demultiplexer for demultiplexing the multiplexed upstream signal according to a wavelength, and a plurality of central office receivers for receiving and restoring the demultiplexed upstream signals, the apparatus comprising:
a control light source located in front of the central office optical multiplexer;
loop-back means for transmitting control light, which is output from the control light source, to the central office through the remote node optical demultiplexer or remote node optical multiplexer;
a control light receiver for receiving looped-back control light; and
a control unit for maintaining power of the upstream signals, which are received by the central office receivers, and power of the control light, which is received by the control light receiver, at a maximum.

2. The apparatus as set forth in claim 1, wherein the control light source is formed of a Light Emitting Diode (LED).

3. The apparatus as set forth in claim 1, wherein the central office light sources are formed of single mode light sources.

4. The apparatus as set forth in claim 1, wherein the control unit comprises a central light source controller for maintaining the power of the received upstream signals at a maximum by varying temperatures of the central office light sources based on the power of the upstream signals received by the central office receivers.

5. The apparatus as set forth in claim 4, further comprising thermal device modules that are attached to the central office light sources and are used to vary the temperatures of the central office light sources under the control of the control unit.

6. The apparatus as set forth in claim 1, wherein the control unit comprises a control light source controller for maintaining the power of the received control light at a maximum by varying temperatures of the central office optical multiplexer and the central office optical demultiplexer based on the power of the control light received by the control light receiver.

7. The apparatus as set forth in claim 6, further comprising thermal device modules that are attached to the central office optical multiplexer and the central office optical demultiplexer and are used to vary the temperatures of the central office optical multiplexer and the central office optical demultiplexer under control of the control unit.

8. The apparatus as set forth in claim 1, further comprising a circulator that is located in the central office and transmits the optical signal, which is reflected and returned by Fresnel reflection through downstream optical fibers to the control unit.

9. The apparatus as set forth in claim 1, wherein the control unit further comprises:
a downstream optical fiber breakage determination unit for determining whether the downstream optical fiber has been broken based on a size of the optical signal reflected and returned by Fresnel reflection through the downstream optical fiber; and
a upstream optical fiber breakage determination unit for determining that an upstream optical fiber has been broken when each of the upstream signals input to the central office receivers is less than a reference value.

10. The apparatus as set forth in claim 9, wherein the upstream optical fiber breakage determination unit is formed of a NAND gate.

11. The apparatus as set forth in claim 1, wherein the central office optical multiplexer and the central office optical demultiplexer are formed of Arranged Waveguide Gratings (AWGs).

12. The apparatus as set forth in claim 1, wherein the loop-back means is constructed by connecting the remote node optical demultiplexer with the remote node optical multiplexer through an optical fiber.

13. The apparatus as set forth in claim. 1, wherein the loop-back means is formed of an optical reflector.

14. The apparatus as set forth in claim 13, further comprising an optical absorber for absorbing the control light input to the remote node optical demultiplexer.

15. The apparatus as set forth in claim 1, further comprising:
a coupler located between the remote node and the optical network terminals and configured to branch the downstream optical signal to be demultiplexed and assigned to the optical network terminals; and
a circulator located between the coupler and the optical network terminals and configured to adjust a direction of the upstream optical signal transmitted from the optical network terminals.

16. The apparatus as set forth in claim 1, further comprising:
a coupler located between the central office and the remote node optical multiplexer and configured to branch the multiplexed downstream optical signal; and
a circulator located between the coupler and the remote node optical multiplexer, and configured to transmit part of the downstream optical signal, which is branched off by the coupler, to the optical network terminals and to transmit the upstream optical signal, which is transmitted from the optical network terminals, to the central office.

17. The apparatus as set forth in claim 1, further comprising:
a coupler located between the central office and the remote node optical multiplexer and configured to branch the multiplexed downstream optical signal; and
a circulator located between the central office optical multiplexer and the coupler and configured to adjust a direction of the multiplexed downstream or upstream optical signal.

18. A method of managing faults of a loop-back WDM-PON, the WDM-PON having a plurality of light sources located in a central office, assigned to optical network terminals and configured to output downstream signals using unique wavelengths, a central office optical multiplexer for multiplexing the optical signals output from the plurality of central office light sources, a remote node optical demultiplexer for separating the multiplexed downstream signal according to a wavelength through demultiplexing and providing the separated downstream signals to corresponding optical network terminals, a remote node optical multiplexer for multiplexing upstream signals remodulated by the plurality of optical network terminals, a central office optical demultiplexer for demultiplexing the multiplexed upstream signal according to a wavelength, and a plurality of central office receivers for receiving and restoring the demultiplexed upstream signals, the method comprising:
the first step of multiplexing control light output from a control light source, along with the downstream signal;
the second step of passing the control light through the remote node optical demultiplexer and the remote node optical multiplexer, multiplexing the control light along with the upstream signal, and transmitting the multiplexed signal to the central office in a loop-back manner;
the third step of separating the signal, which is received by the central office, into the control light and the upstream signal by demultiplexing the signal; and
the fourth step of maintaining power of the upstream signals received by the central office receivers and power of the control light received by the control light receiver at a maximum.

19. The method as set forth in claim 18, wherein the control light source is formed of an LED.

20. The method as set forth in claim 18, wherein the central office light sources are formed of single mode light sources.

21. The method as set forth in claim 18, wherein the fourth step is performed by maintaining the power of the received upstream signals at a maximum by varying temperatures of the central office light sources based on the power of the upstream signals received by the central office receivers.

22. The method as set forth in claim 18, wherein the fourth step is performed by maintaining the power of the received control light at a maximum by varying temperatures of the central office optical multiplexer and the central office optical demultiplexer based on the power of the control light received by the control light receiver.

23. The method as set forth in claim 18, further comprising the steps of:
determining whether the downstream optical fiber has been broken based on a size of the optical signal reflected and returned by Fresnel reflection through the downstream optical fiber; and
determining that an upstream optical fiber has been broken when each of the upstream signals input to the central office receivers is less than a reference value.
